(19) United States
(12) Patent Application Publication
(10) Pub. No.: US 2014/0074746 A1
(43) Pub. Date: Mar. 13, 2014

(54) PACKAGE SOURCE VERIFICATION

(71) Applicant: Ynjiun P. WANG, Cupertino, NY (US)

(72) Inventor: Ynjiun P. WANG, Cupertino, NY (US)

(73) Assignee: Hand Held Products Inc. doing business as (d.b.a) Honeywell Scanning & Mobility, Fort Mill, SC (US)

(21) Appl. No.: 13/606,168

(22) Filed: Sep. 7, 2012

(51) Int. Cl. G06Q 50/28

(52) U.S. Cl. 705/341

(57) ABSTRACT

Verification of a source of a package is facilitated. A data terminal certified by an authority obtains location data from a location detection component. The location data indicates a source location from which the package is to be shipped, and is detected by the location detection component at the source location. Secure package shipment information, including the location data, is provided with the package to securely convey the detected source location to facilitate verifying the source of the package. The data terminal can be a portable data terminal certified by the authority and have a tamper-proof boundary behind which resides the location detection component and one or more keys for securing the package shipment information. Upon tampering with the tamper-resistant boundary, the certification of the portable data terminal can be nullified.

### BACKGROUND

Millions of domestic and international packages are shipped each day to remote locations. Packages originate from an originating location, usually a shipper's location, and are shipped to a final destination, possibly passing through various intermediary points en route to that final destination. Typically, a shipping label is placed directly on the package to identify one or more of: the shipper, usually an individual or company name; a source location of the package; a recipient, usually an individual or company name; a destination location; and/or additional package information, such as package weight or dimensions. The source label might therefore indicate that the package's source location is Company A's headquarters. Presently, however, there is no effective way to verify that the indicated source location is accurate, or that such information has not been changed while the package is en route to its final destination.

### BRIEF SUMMARY

The shortcomings of the prior art are overcome and additional advantages are provided through the provision of a method to facilitate verifying a source of a package. The method includes, for instance, obtaining, by a data terminal certified by an authority, location data from a location detection component of the certified data terminal, the location data indicating a source location from which the package is to be shipped, the source location detected by the location detection component when at the source location; and providing, with the package, secure package shipment information, the secure package shipment information including the location data indicating the detected source location of the package, wherein the secure package shipment information securely conveys the detected source location of the package to facilitate verifying the source of the package.

Additionally, a system is provided for facilitating verification of a source of a package. The system includes a data terminal, which includes: a processor; a location detection component; and a memory in communication with the processor and storing instructions for execution to perform a method including, for instance: obtaining location data from the location detection component, the location data indicating a source location from which the package is to be shipped, the source location detected by the location detection component when at the source location; and providing, with the package, secure package shipment information, the secure package shipment information including the location data indicating the detected source location of the package, wherein the secure package shipment information securely conveys the detected source location of the package to facilitate verifying the source of the package, and wherein the data terminal is certified by an authority to provide the secure package shipment information.

Further, a computer program product is provided for facilitating verification of a source of a package. The computer program product includes a computer readable storage medium readable by a processor and storing instructions for execution by the processor to perform a method including, for instance: obtaining, by a data terminal certified by an authority, location data from a location detection component of the certified data terminal, the location data indicating a source location from which the package is to be shipped, the source location detected by the location detection component when at the source location; and providing, with the package, secure package shipment information, the secure package shipment information including the location data indicating the detected source location of the package, wherein the secure package shipment information securely conveys the detected source location of the package to facilitate verifying the source of the package.

Yet further, a portable data terminal is provided for facilitating verification of a source of a package, the portable data terminal being certified by an authority, and the portable data terminal including: a processor; a global positioning system device, the global positioning system device providing, to the processor, location data indicating a source location from which the package is to be shipped, the source location detected by the global positioning device when at the source location, wherein the global positioning system device is present behind a tamper-resistant boundary of the portable data terminal, wherein certification of the portable data terminal by the authority certifies that the location data provided by the global positioning system device is trustworthy, and wherein tampering with the tamper-resistant boundary nullifies the certification of the portable data terminal; and a memory in communication with the processor and storing instructions for execution to perform a method including, for instance: using a key verified by the authority and included behind the tamper-resistant boundary of the portable data terminal to perform at least one selected from the group consisting of (i) encrypting package shipment information to obtain secure package shipment information and (ii) signing package shipment information to obtain secure package shipment information, and wherein tampering with the tamper-resistant boundary erases the key; and providing, with the package, the secure package shipment information, wherein the secure package shipment information securely conveys the detected source location of the package to facilitate verifying the source of the package.

Additional features and advantages are realized through the concepts of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts an example system to incorporate and use one or more aspects of the present invention;

FIGS. 2A-2C depict examples of providing secure package shipment information, in accordance with one or more aspects of the present invention;

FIG. 3 depicts one example of a process to facilitate verifying a source of a package, in accordance with one or more aspects of the present invention;

FIG. 4 depicts one example of a portable data terminal, in accordance with one or more aspects of the present invention; and

FIG. 5 depicts one example of a computer program product to incorporate and use one or more aspects of the present invention.

### DETAILED DESCRIPTION

There is a need to verify whether a purported source of a package (also referred to herein as a “shipment”) is accurate. In the import/export of goods, counterfeiting and piracy are significant concerns. Millions of packages arrive in the United States, for instance, each year. These packages are screened to a greater or lesser extent by the United States Customs and Border Protection agency. However, the screening process is tedious, and it is not feasible to open and verify the contents of each package in order to determine whether the contents are legitimate. One approach, therefore, is to identify, by a shipping label or some other documentation provided with the package, a source of the package, and accept that the package and its contents are legitimate based on some established level of trust with that source. For instance, if a shipping label indicates that the package originated from a trusted manufacturing facility overseas, then any package arriving from that facility may be automatically trusted, or at least be subject to a lower level of screening.

Assurance as to whether the package shipment information indicated on the shipping label or otherwise accompanying the package is accurate may not be an easy task. A counterfeiter can ship a counterfeit product from one location but provide fraudulent package shipment information. The fraudulent package shipment information might indicate that the package was shipped from a location of the manufacturer of the legitimate product being counterfeited, rather than the location counterfeiter.

Aspects of the present invention advantageously leverage location detection technology, such as global positioning system (GPS) technology, to provide a facility for verifying the source of a shipment. As an overview, the package, when shipped, is provided with an indication of the true location from which the package originates. That indicated location is secured and later verified by a receiver of the package against, for instance, a stated source location on the package or a list of known or expected locations of the manufacturer or provider of the item(s) being shipped. If the originating location of the package is a location other than the location indicated on/with the package, or if the secured indication of the source location has been tampered-with, the package can be flagged as being non-trustworthy. Thus, illegitimate packages can be identified based on where (e.g. global location) the shipment originated.

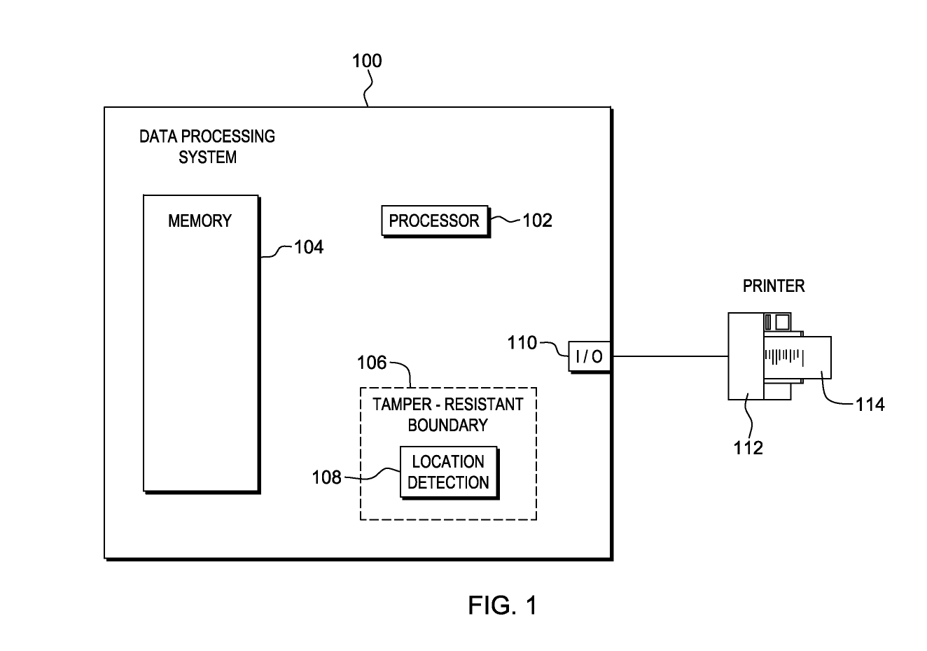

FIG. 1 depicts an example system to incorporate and use one or more aspects of the present invention. In FIG. 1, data processing system 100 includes one or more processor(s) 102 and memory 104. Processor(s) 102 comprises any appropriate hardware component(s) capable of executing one or more instructions from memory 104, as is appreciated by those having ordinary skill in the art. In one embodiment, a processor comprises a central processing unit. Memory 104 stores data including, for instance, program code for execution to perform one or more aspects of the invention, as described in further detail below.

Data processing system 100 also includes a tamper-resistant boundary 106 behind which is provided a location detection component 108. Tamper-resistant boundary 106 includes, for instance, a tamper-resistant physical enclosure that encloses at least a portion of location detection component 108. If tamper-resistant boundary 106 is tampered with, functionality of location detection component 108 can be disabled and/or an indication can be provided (such as to the processor or operator of the data processing system) that tampering has occurred to tamper-resistant boundary 106. In one example, where location detection component 108 is dependent on a supply of power, then tampering with tamper-resistant boundary 106 causes power to no longer be applied to location detection component 108, thereby rendering it unusable. In another example, where tamper-resistant boundary 106 includes a tamper-resistant enclosure, if the enclosure is tampered-with (broken, pried, snapped, invaded, etc.), data processing system 100 can be made aware of this and disable some or all functionality thereof. In yet a further example, when tamper-resistant boundary 106 is tampered-with, location detection component 108 can be rendered permanently disabled such that it is unable to provide location data. Program code necessary for proper functioning of location detection component 108 can be, for instance, erased. Further details of the location detection component 108 are provided below.

Additionally, data processing system 100 includes an input/output (I/O) communications interface component 110 for communication between data processing system 100 and external device(s). In one example, I/O communications interface component 110 comprises a network adapter for communicating data between data processing system 100 and other devices on a network to which data processing system 100 is connected. In another embodiment, I/O communications interface component 110 comprises a universal serial bus (USB) or peripheral component interconnect (PCI) component to communicate with peripheral devices. One such peripheral device, as depicted in FIG. 1, is a printer 112. Printer 112 can be used by data processing system 100 to print a shipping or source label 114 with package shipment information specified thereon, or encoded as encoded information (e.g. a mark, such as a bar code) and placed on to the package. Thus, in one mode of operation, data processing system 100 generates and prints a label or other form of indicia that carries information, such as secure package shipment information.

Though processor(s) 102, memory 104, and I/O 110 of data processing system 100 are depicted as being outside of tamper-resistant boundary 106 in FIG. 1, it should be appreciated that tamper-resistant boundary 106 may in fact include/surround some or all of processor(s) 102, memory 104, and/or I/O 110. For instance, at least a portion of memory 104 may be included within tamper-resistant boundary 106 to protect the portion of memory 104 included therein. In one example, tamper-resistant boundary 106 functions as a sealed storage facility for the portion of memory included within boundary 106, so as to secure and protect data stored in that memory. To protect data in the sealed storage, data processing system 100 or a component thereof may be configured to automatically erase the portion of memory 104 behind the tamper-resistant boundary 106 upon physical tampering with tamper-resistant boundary 106. In one example, tamper-resistant boundary 106 forms a housing encompassing/enclosing the entirety of data processing system 100.

Tamper-resistant boundary 106 is thus provided to safeguard one or more components and/or data of data processing system 100, and in this example to safeguard location detection component 108 to ensure that any data produced therefrom is accurate. Inclusion of location detection component 108 within boundary 106, as depicted in FIG. 1, can ensure that location data generated by location detection component for provision to processor(s) 102 (which may or may not also be included within boundary 106) is genuine (i.e. not spoofed to indicate a location other than that detected by location detection component 108). This is useful for ensuring that the generated location data is accurate.

The accuracy of the location data, and optionally additional package shipment information, such as the timing of carrier pickup, the weight, or the dimensions of the package, or item descriptions(s) can be secured and later verified by a recipient (final recipient or intermediate recipient) of the package. In one example, data processing system 100 comprises a portable data terminal (PDT), such as one carried by package carriers to facilitate various shipping and tracking activities, as is appreciated by those having ordinary skill in the art. The PDT can also be used, in accordance with aspects of the present invention, by the carrier at the pickup (source) location to print a shipping or source label that includes an indication of the source location. This source location can be provided by location detection component 108 to accurately indicate the pickup location, since location detection component 108 will be physically located at that pickup location.

Ensuring the authenticity of the source location of the package, such as the location detected by the location detection component 108 of data processing system 100, is useful in the above example to ensure that the indicated source location is accurate. This source location will be verified upon receipt of the package. Thus, package shipment information, including the accurate location data provided by location detection component 108 and, optionally, including additional shipment information, should be secured. The package shipment information is secured to prevent duplication of, or modification to, the package shipment information. If the accurate location data were simply printed onto the package being shipped, without being secured, a nefarious actor could modify the location data or other package shipment information on the package (by printing a replacement label for instance), and the recipient would have no way of knowing this.

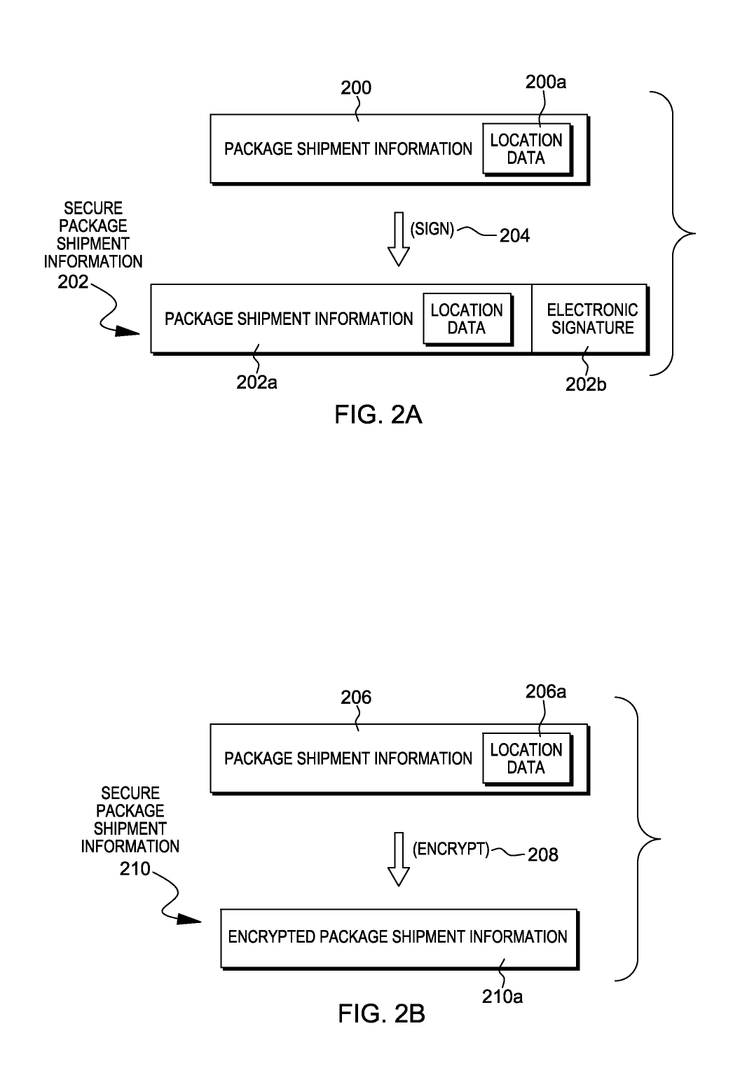

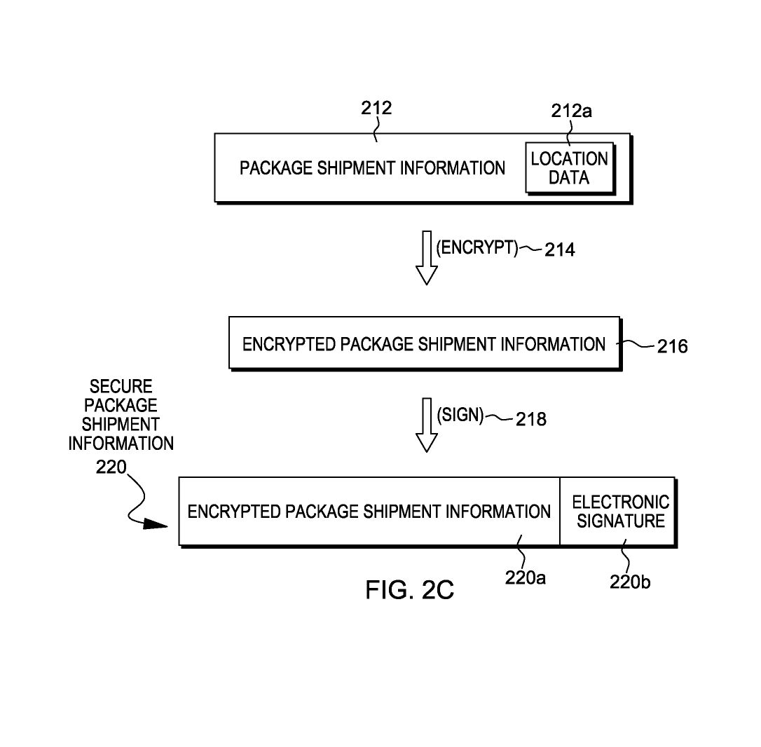

Thus, in accordance with aspects of the present invention, secured package shipment information is provided, based on package shipment information including location data. In one example, this is provided by a carrier's PDT at the source location when the package is picked up by the carrier. FIGS. 2A-2C depict examples of providing secure package shipment information, in accordance with one or more aspects of the present invention.

In FIG. 2A, package shipment information 200, which includes location data 200a, is electronically signed (204) to obtain secure package shipment information 202. Secure package shipment information 202, in this case, includes package shipment information 202a (the same as package shipment information 200) provided with an electronic signature 202b. Electronic signature 202b is, in this example, appended to package shipment information 202a.

“Digitally signing” or “electronically signing” (the two phrases are used interchangeably herein) the package shipment information is achieved through various known techniques. For completeness, a brief overview of one example of an electronic signature scheme is now provided.

Affixing a party's electronic signature (or “digital signature”) to some information, data, or message allows another party to examine the signature and verify that the signature is authentic with respect to the signing party. Typically, a private key of a pair of keys (including one private key and one public key, in accordance with known key generation algorithms) is used for generating the signature, and the public key is used to verifying that signature. Given information, data, a message, etc. and a private key, a party can produce an electronic signature. Usually, the information/data/message to be signed is hashed or checksummed, and that hash or checksum is encrypted using the private key. The encrypted hash/checksum becomes the electronic signature. In one example, the hash/checksum of the message is provided to a smart card or similar integrated circuit card, a processor of the smart card encrypts the hash using a private key stored on the smart card, the private key being inaccessible to outsiders, and then the smart card returns the encrypted hash. In some examples, a user activates the smart card by providing authentication information such as a PIN. In other examples, the smart card securely provides a key by way of a signed certificate to a data processing system (such as data processing system 100) which receives the key to perform the encryption of the hash.

A recipient party of the signed information/data/message can verify, given the information/data/message that is signed, the public key of the key pair, and the electronic signature, whether the information/data/message is authentic. For instance, the recipient party can decrypt, using the counterpart (i.e. public) key of the key use to encrypt the hash (i.e. private key), the encrypted signature to obtain the hash/checksum generated by the signing party. Then, the recipient party can separately hash/checksum the information/data/message using the same agreed-upon hashing/checksumming algorithm, and compare the two hashes/checksums. A match indicates that the information/data/message being conveyed remained static (unmodified) during conveyance of the information/data/message. A mismatch indicates either that the message was modified after being signed, or that it was not signed in the first place with the counterpart key to the key used for decrypting the signature (i.e. was not signed by the private key that is the counterpart of the public key that was used to decrypt the signature). The key-pair scheme relies on the fact that it should be virtually impossible for a nefarious actor who does not possess a party's private key to generate a valid signature of that party.

An electronic signature can provide at least three assurances as to the data being electronically signed. First, it provides authentication as to the source of the data, when that data is signed with a private key. A valid signature, i.e. one that is generated from the user's private key which is usually kept tightly secured and not generally available, shows that the message was sent by the user.

Second, it assures that the data which is signed has not been modified. Any change to the data after it is signed will cause a non-matching checksum/hash to be generated by the receiving party. In such a case, the signature of the signing party would also need to be modified by the nefarious actor. However, it is virtually impossible for a nefarious actor to modify data and, at the same time, to (correctly) modify the signature of that data to produce a valid signature for the modified data.

Third, an electronic signature provides assurance for non-repudiation of origin. When a sending party signs data using the party's private key, it cannot simultaneously repudiate that signature (claim that the party did not sign the data) while also claiming that the party's private key is in fact private.

Returning to the example of FIG. 2A, package shipment information 200 is signed (204) by appending electronic signature 202b to package shipment information 202a to provide secure package shipment information 202. Secure package shipment information 202 can then be provided with the package (e.g. encoded as part of a bar code, for instance, printed on a source label and attached to the package). When the package is received by another party seeking to verify the source of the package, the recipient can use the other key, for instance the public key corresponding to the private key used to sign the label, to verify that the provided signature is accurate given the package shipment information indicated by the source label.

FIG. 2B depicts another example of providing secure package shipment information in accordance with one or more aspects of the present invention. In FIG. 2B, package shipment information 206, including location data 206a, is encrypted (208) using a key to obtain secure package shipment information 210. Secure package shipment information 210 in this example includes encrypted package shipment information 210a, i.e. an encrypted form of package shipment information 206. Thus, in this example, the package shipment information is encrypted using, for instance, a known encryption technique.

In some embodiments, a combination of encryption and electronic signature is used to provide secure package shipment information. FIG. 2C depicts one such example. In FIG. 2C, package shipment information 212 including location data 212a is first encrypted (214) to obtain encrypted package shipment information 216. Encrypted package shipment information 216 is then electronically signed (218) to obtain secure package shipment information 220, which includes encrypted package shipment information 220a (essentially the same as encrypted package shipment information 216) and electronic signature 220b. One benefit from first encrypting the package shipment information is that it obfuscates the data being signed (i.e. the encrypted package shipment information) to make it generally indecipherable, providing an added layer of security to the original package shipment information.

In a modified version of the sequence of FIG. 2C, the package shipment information is first electronically signed, and then the package shipment information together with the electronic signature is encrypted to obtain the secure package shipment information. In either case, both a combination of encryption and electronic signing are used to provide the secure package shipment information.

In order to facilitate the encryption and/or the electronic signature activities, one or more keys are used. When multiple keys are used, one or more can be used to sign the package shipment information, and one or more can be used to encrypt the package shipment information. The key(s) used can be owned or verified by one or more different sources depending on the entities for which the source information is to be authenticated. In one example, a recipient of the package (either the entity to which the package is sent, or an entity through which the package passes en route to its final destination) provides a key or verifies, by signing, a digital certificate that includes a key, and that provided or verified key is provided to, or preexists within, the data processing system for use in providing the secure package shipment information with the package when shipped. In a more particularized example, an authority, such as a national border protection or customs agency, or other governmental authority, provides, issues, or verifies (by signing a digital certificate, for instance) one or more keys or key pairs, and the agency or authority uses one or more counterpart keys of the provided/issued/verified key in order to verify the secure package shipment information and the source of the package when the package enters the country.

In another example, a key used for providing the secure package shipment information belongs to the shipper of the package, whereby one of the shipper's keys (e.g. private key) is used to encrypt and/or sign the package shipment information, and the shipper provides the counterpart key (e.g. public key) to a recipient (final or intermediate), such as a national customs and border protection agency, so that the recipient can verify the secure package shipment information and package source, as discussed above. The shipper may, at the time the package is picked up by a carrier, provide (e.g. by way of a smart card or a near-field communication device) the key for encrypting and/or signing the package shipment information. The key can be provided to the carrier's portable data terminal which then performs the encrypting and/or the signing to generate the secure package shipment information. Alternatively or additionally, the shipper performs at least some of the securing of the package shipment information using data provided by the carrier's portable data terminal, and the secure package shipment information is returned to the carrier's portable data terminal to generate a source label to place on/with the package.

In all cases, one or more keys provided by one or more sources may be used for securing the package shipment information. For instance, a carrier-provided key, a government agency-provided key, and a shipper-provided key may all be used to separately or in combination generate secure package shipment information that can be verified by a recipient of the package. In one example, a shipper's key and a government agency's key may both be used to separately sign the package shipment information, and/or may be used to doubly-encrypt the package shipment information before or after signing. A government agency representative, when the package reaches the nation's customs area, can verify the integrity of both signatures. Additionally or alternatively, one key is used to encrypt the package shipment information, and the other key is used to sign the (encrypted) package shipment information.

In a further example, the carrier is provided (e.g. within the PDT used at package pickup) its own private key by a customs authority, and also provided with a public key of that customs authority. At package pickup, package shipment information, including the location data, is first signed using the private key of the carrier, and then encrypted using the public key of the authority. Then, upon receipt of the package by the customs authority, the authority first decrypts the signed package shipment information using the authority's private key (counterpart to the public key used to perform the encryption), and then verifies, using the public key counterpart to the carrier's private key, the signature by the carrier.

In some embodiments, one or more keys are securely stored in the data processing system (e.g. FIG. 1, #100) to protect the keys from publication. The one or more keys may be stored behind a tamper-resistant boundary (e.g. in a memory included therein), which can be configured to automatically erase the key(s) if the boundary is tampered-with. The key(s) may be stored permanently therein. Alternatively, one or more keys may temporarily therein, for instance in the case that a key is received, by way of a secure data communication tunnel, from a shipper when the package is picked up by the carrier from the source location and used ad hoc to secure the package shipment information. In this manner, the shipper-provided key is provided in a secure fashion to the data processing system, which stores the key temporarily in memory within the tamper-resistant boundary in order to use to secure package shipment information. The shipper-provided key can then be erased.

Ensuring protection of key(s) that are used by a data processing system to provide secure package shipment information allows, for instance, one or more entities to securely provide a private key to the data processing system. In general, an entity does not wish to provide its private key to another system, such as a data processing system under control of a package carrier. However, the tamper-resistant boundary can provide assurance that private key(s) belonging to entities other than an operator of the data processing system are protected. Thus, a shipper and/or government agency could provide its private key for storage on the data processing system (e.g. behind a tamper-resistant boundary thereof). In some example, an entity's private key is generated during manufacture of the PDT and made known to the authority at that time.

When a private key is stored on the PDT, the key owner could publicize its corresponding public key for anyone, who would be able to freely use the public key to verify the source of the package. In one particular example, a shipper provides its private key to a carrier at the shipper's location when shipping a package. The carrier uses the supplied private key to generate and tag the package with secure package shipment information. The package is then shipped and the shipper directs a recipient of the package to the shipper's public key (for instance by posting it on the shipper's website). The recipient, upon receiving the package, could use a data processing system, such as a portable data terminal, along with the public key to verify the secure package shipment information, for instance by decrypting the package shipment information, and/or determining whether the provided signature is accurate given the message it signs. In this case, although a nefarious actor could use the public key the same way the recipient could (i.e. to determine the package shipment information for instance), the nefarious actor is unable to produce an accurate replacement label. For instance, the nefarious actor, since he does not possess the private key, could not produce spoofed package shipment information (such as a spoofed source location) and re-encrypt or re-sign that spoofed information to produce meaningful secure package shipment information that is verifiable using the counterpart public key.

Alternatively or additionally, public keys could be provided to the data processing system for performing the securing of the package shipment information. In such an example, a public key is used to encrypt the package shipment information, and the corresponding private key remains in possession and under the control of the recipient of the package. In this manner, confidentiality is preserved in that only the recipient is able to decrypt and read the source of the package, since only the recipient possesses the private key necessary for the validation.

According to one or more aspects of the present invention, a tamper-resistant portable data terminal (PDT) having an embedded location detection component (i.e. a global positioning system (GPS) device included within a tamper-resistant boundary) is provided with a portable printer or embedded printing facility. The PDT is loaded with one or more certificates, having one or more keys and the certificate(s) being loaded into memory, such as secure storage included in the tamper-resistant boundary. The certificate(s) are provided by, or signed by, a certificate authority. The PDT uses the one or more keys to encrypt and/or sign location data obtained from the GPS device, which location data indicates the pickup location of a package to be shipped. The GPS device receives transmissions from a plurality of global positioning satellites when the PDT is located at the pickup location. The transmissions indicate to the GPS the location of the GPS device inside of the PDT, and therefore indicate the source location. That indication of the source location is secured (encrypted and/or signed) and provided with the package. In one example, the secure location information is provided with the package as a scannable bar code. If the PDT is tampered-with, and more specifically, if the tamper-resistant boundary is tampered-with, the certificate(s) can be automatically erased by way of known technology, such as separate circuitry, to ensure that the key(s) are destroyed before being copied or read.

Thus, the PDT and/or components thereof are tamperproof such that if a nefarious actor tampers with the tamper-resistant boundary, a change in state, such as erasure of data key(s) or processing algorithms, or disabling of components such as the location detection component, is effected.

In one embodiment, the PDT is certified by an authority before it is trusted to perform the securing of package shipment information. In this manner, PDTs that are not certified may be deemed untrustworthy. The authority could be a government agency. A government agency, such as United States Customs and Border Protection (CBP), can require that freight or other package shipment carriers (such as United Parcel Service, Inc. (UPS®), or FedEx Corporation (FedEx®)) use a certified device to facilitate verification by CBP of the source of packages entering the country. Certification of the device by the authority can include any combination of activities that provide adequate assurance that the device will securely convey accurate location data and/or other package shipment information. The authority can require that the PDT be manufactured according to particular specifications that provide assurance as to the integrity of the components of the PDT. The authority can additionally or alternatively evaluate the integrity of the device against a set of guidelines or expected characteristics of the device. In one example, the authority verifies the integrity of the tamper-resistant boundary and the GPS device. Additionally or alternatively, the authority can inject (program, provide, store) one or more keys owned and/or verified by the authority into the device (i.e. into storage behind the tamper-resistance boundary) as part of the certification procedure. In one particular embodiment, the authority issues a public/private key pair to a package carrier, and the private key is securely stored in the certified portable data terminal, and, if the tamper-resistant boundary should later be broken or tampered-with, certification of the PDT by the authority is automatically nullified, for instance by automatically erasing the stored private key. The private key can be used to sign package shipment information. Optionally, as part of the certification process, a public key of the certifying authority is also stored in the portable data terminal, and the public key is used to securely convey information, such as the signed package shipment information, to the authority, whereby the authority decrypts the securely conveyed information upon receipt of the package by the authority.

A certified PDT having a trusted location detection component can be provided to trusted carriers (such as UPS, FedEx, etc.). In some embodiments, where the PDT is not provided with internal printing capabilities, and portable printer is provided with the PDT, where the PDT can securely provide information, such as secure package shipment information, to the printer for printing. The carrier, upon receiving a package at a source location, can provide secure package shipment information with the package. The carrier can, for example, print a source label, such as an Aztec code or QR code, at the location of pickup and attach the label to the package to be shipped. The label or other provided information includes an encrypted and/or signed indication of a GPS-derived location that indicates the source location of the package when it was picked up by the carrier. Optionally, the package shipment information being secured, and/or other information provided on the source label can include additional shipment information, such as package weight, dimensions, color, or other characteristics, or item descriptions, quantity etc.

In one example, when a carrier picks up a package for shipment, the carrier obtains shipment information, such as shipper and/or destination address, timestamp, package characteristics, etc. One example manner in which the shipment information is obtained is by scanning a bar code or other encoded information already provided with the package or by the shipper at the time of pickup. In another example, this information is provided to the carrier's PDT via a data communication network of the carrier after the shipper schedules/creates a package shipment request through the carrier's website or other facility. It is possible, for instance, for a shipper to schedule a package pickup using a web-interface whereby the shipper enters the necessary shipment information, and that shipment information is transmitted to a data processing system (e.g. PDT) of the carrier or otherwise preloaded thereon, and the carrier travels to the shipper's location to obtain the package to be shipped.

The PDT, once the shipment information is obtained, can combine all, some, or none of the shipment information with obtained GPS location data, obtained by the location detection component of the PDT, and use key(s), such as the authority-issued, provided, or verified key(s) to sign and/or encrypt some or all of the combined information. The signed/encrypted information provides assurance as to the package's source. Even if some of the package shipment information is inaccurate (for instance spoofed by a counterfeiter to indicate the shipper address as being a legitimate manufacturer), the GPS location data will indicate the true pickup location of the package, which will not match the location of the legitimate manufacturer unless the counterfeiter successfully shipped the package from the manufacturer's location. Additionally, the global positioning system can provide a timestamp along with location information. This timestamp can also be included in the secure package shipment information to provide another layer of assurance as to the source of the package. For instance, if the shipment information of the package indicates that the package was picked up and shipped 10 days prior, but the secure package shipment information indicates that the source label was generated 2 days prior, this can raise suspicion as to the source of the package, even if the location data indicates the location of the legitimate manufacturer. As described above, the signing and/or encrypting of the package shipment information provides another layer of security, in that a recipient can use one or more keys to decrypt the secure package shipment information and/or verify the signature provided as part of the secure package shipment information, in order to verify its integrity.

Advantageously, in embodiments where package shipment information is signed (but not encrypted), it enables the package shipment information to be observable/readable by entities (such as intermediate recipients of the package on its way to its final destination), while providing the ability to verify (by way of the signature) that the package shipment information is valid and/or has not been changed.

In some embodiments, signature of a government authority on the package shipment information, or encryption of signed package shipment information, is provided (by way of a public key or private key injected into the device by that authority when the device is certified for use by the authority). A shipper signature may further be provided on the package shipment information (where the shipper electronically signs the package shipment information if the shipper has an electronic certificate). The latter signature provides authentication and non-repudiation with respect to the shipper of the package. In one particular example, a certificate authority, such as a government agency, or private authority, such as Verisign, Inc., issues the shipper a certified certificate after the shipper registers itself with the authority and undergoes an evaluation by the authority evaluating and certifying the shipper's authenticity. For instance, the shipper may be registered with the authority as a legitimate manufacturer of particular goods, and the authority can provide the shipper with a certificate (containing a key unique to the shipper) that is used to sign/encrypt package shipment information, to prove to a recipient of a package that the shipper is registered with the authority, and thus that the shipment is legitimate.

The authority can similarly issue the package carrier a key for signing/encrypting the package shipment information to provide non-repudiation and authentication with respect to the carrier of the package.

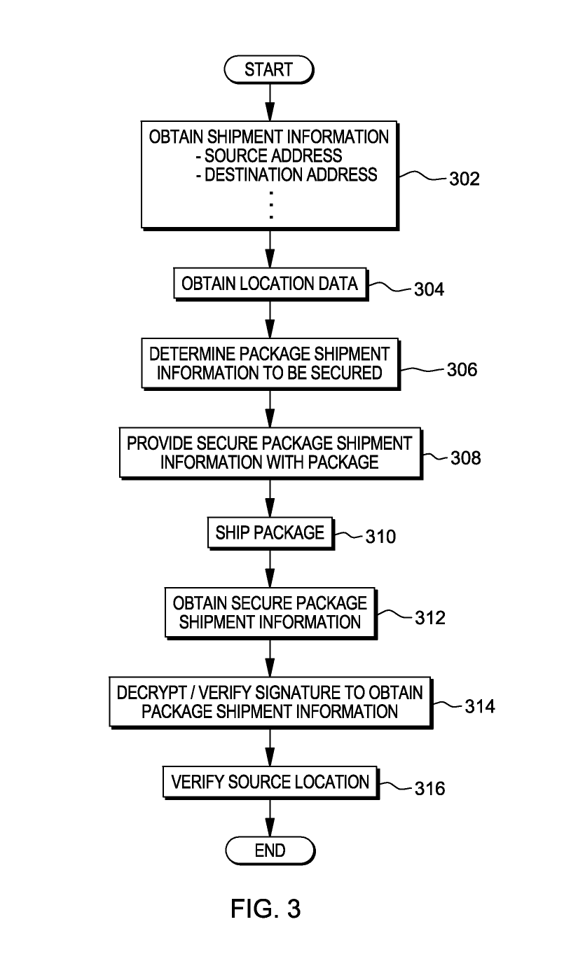

By the above, a process is described to facilitate verifying a source of a package, in accordance with one or more aspects of the present invention. FIG. 3 depicts one example of such a process. The process begins with obtaining shipment information (302), e.g. information about the shipment being initiated by a shipper. Such shipment information might include a source (shipper) address, a destination address, and other information such as item description or package dimensions, weight, etc. In one example, this information is obtained by the package carrier when the carrier picks up the package at the source location, which may be, for instance, a manufacturer of the item(s) being shipped. In one example, the shipment information is obtained by reading, by a portable data terminal, the bar code placed onto the package by the shipper, which bar code includes the shipment information encoded therein. In another example, the shipment information is transferred from a shipper-maintained device to the carrier's portable data terminal by way of a wireless technology such as RFID. In yet another example, the shipment information might be preloaded into the carrier's portable data terminal. As described above, some carriers enable customers to initiate shipments via a website whereby a package pickup is scheduled after the shipper enters information about the shipment. In some instances, the customer is provided with a shipping label to print and provide with the package, and in other instances, the information is automatically transferred to a carrier's portable data terminal in order to preload the shipment information.

Next, location data is obtained from a location detection component of the certified portable data terminal (304). The location data indicates the source location (i.e. location of the carrier at pickup, which is the location of the location detection component) from which the package is to be shipped. The package shipment information that is to be secured is then determined (306). As described above, the package shipment information comprises the obtained location data and optionally any additional information, such as any of the shipment information obtained above (302). In one example, the location data is combined with a timestamp and/or shipment information, such as item descriptions, quantity, etc., and/or package dimensions, weight, or other characteristics.

Once the package shipment information to be secured is determined, the package is provided with a secure version of that package shipment information (i.e. provided with secure package shipment information) (308). The secure package shipment information includes the location data indicating the detected source location. The secure package shipment information securely conveys this detected source location. The package shipment information can be encrypted and/or signed using one or more keys. For instance, one or more authority-controlled, carrier-controlled, and/or shipper-controlled key(s) are used to secure the package shipment information. A key of the shipper may be obtained by NFC or smart card communication with the portable data terminal.

Thus, in an example implementation, a carrier arrives at a shipper's location and scans a bar code on the package with a portable data terminal to obtain shipment information about the package to be shipped. Then, the portable data terminal by way of the location detection component thereof acquires an indication of the location of the portable data terminal, which is the same location as the source of the package, optionally combines that information with shipment information to obtain package shipment information, and secures this package shipment information by way of encryption and/or digital signature. The secure package shipment information is then provided with the package, for example by the PDT printing a source label (e.g. another bar code) that includes the secure package shipment information as part of an encoded mark (e.g. bar code), and the carrier then ships the package (310).

The secure conveyance of the package shipment information to recipient(s) of the package facilitates verification of the source of the package by the final and/or intermediate recipients, for instance by an authority, such as a government agency. Upon package arrival to a recipient, such as arrival at a national customer port of entrance, the secure package shipment information that is provided with the package is obtained (312). In one example, this information is obtained by scanning, with a data processing system such as a portable data terminal described herein, the source label having the bar code with the encoded secure package shipment information. Then, the secure package shipment information is either decrypted, or the validity of a digital signature of at least a portion of the secure package shipment information is verified, or both (314). One or more keys are used to perform the decrypting and/or the verifying, and based on the decrypting/verifying, package shipment information is obtained. At that point, the source location can be verified (316) to determine whether or not the package is to be trusted.

In one example, the recipient uses a key to decrypt a signature appended to the package shipment information to obtain a hash, the recipient itself hashes the package shipment information, and then the recipient compares the obtained hash with the recipient's hash of the package shipment information. A mismatch between the hashes indicates that the appended signature is not an accurate signature of that package shipment information, and therefore the indicated package shipment information cannot be trusted. In another example, the recipient uses a key to decrypt the secure package shipment information to obtain the package shipment information.

In either case, the actual source location of the package can be verified. For instance, the indicated source location (indicated in the package shipment information, which is trusted as being accurate, since it was securely conveyed by either an accurate signature or by encryption, or both) can be compared against other information, such as a source address printed on the package. A mismatch indicates that the package did not originate from the purported source of the package (shipper address on the package).

In one example, the other information to which the source location is compared includes a known location for the manufacture or shipper. If the package's source is purported to be Company A, with a manufacturing facility located at 123 Sunny Drive, the indicated source location (i.e. indicated by the location data) can be compared against this address, 123 Sunny Drive. A mismatch indicates that the package was not actually shipped from Company A's manufacturing facility at 123 Sunny Drive.

Additionally or alternatively, the source location indicated by the location data is compared against a ‘whitelist’—a list of known-to-be reputable and trustworthy originating locations/shippers. If the indicated source location is on the whitelist, the source of the package is verified as accurate, in one example. Additionally or alternatively, the indicated source location is compared against a ‘blacklist’—a list of known-to-be untrusted originating source locations/shippers, and if the indicated source location is on the blacklist, the source of the package is determined to be illegitimate.

Thus, for those vetted or valid shippers, the purported originating location (such as the shipper address) will coincide with the source location indicated by the secure package shipment information.

The verification of the source location is facilitated, in one example, by a portable data terminal in the possession of the recipient. The portable data terminal may be a portable data terminal certified by an authority, as described above. The portable data terminal can be configured (for instance by way of program code or logic), to obtain the secure package shipment information by scanning the source label, which may be a bar code, and performing the decrypting or the verifying of the electronic signature, or both. The portable data terminal may be further configured to verify whether the source location is legitimate as previously described.

In a further embodiment, the path of the package is documented and tracked several times when en route to the package's final destination. At each receiving location (such as a package transfer hub), an additional label (e.g. transit label) can be generated using the location of that receiving location, and provided with the package. Each such additional label can be time-stamped. An entire verifiable history of the locations through which the package traveled and when the package traveled through such locations is provided. This verifiable history is useful if a nefarious actor attempts to tamper with the package when in transit, for instance by adding or removing items, thus changing the package weight and contents. Additionally or alternatively, the verifiable history is useful in the case that the package is temporarily diverted off-course, wherein a transit label added at an unanticipated location will indicate that the package was at the unanticipated location at a particular time.

In some cases, a governmental body, such as a national customs bureau, may work with trusted carriers and require or offer incentives to carriers that use one or more aspects of the present invention, such as a data processing system or portable data terminal having facilities described above. One example of a portable data terminal to facilitate verification of a source of a package is the Dolphin 99EX Mobile Computer offered by Honeywell International Inc. (or a subsidiary thereof), Morristown, N.J., USA.

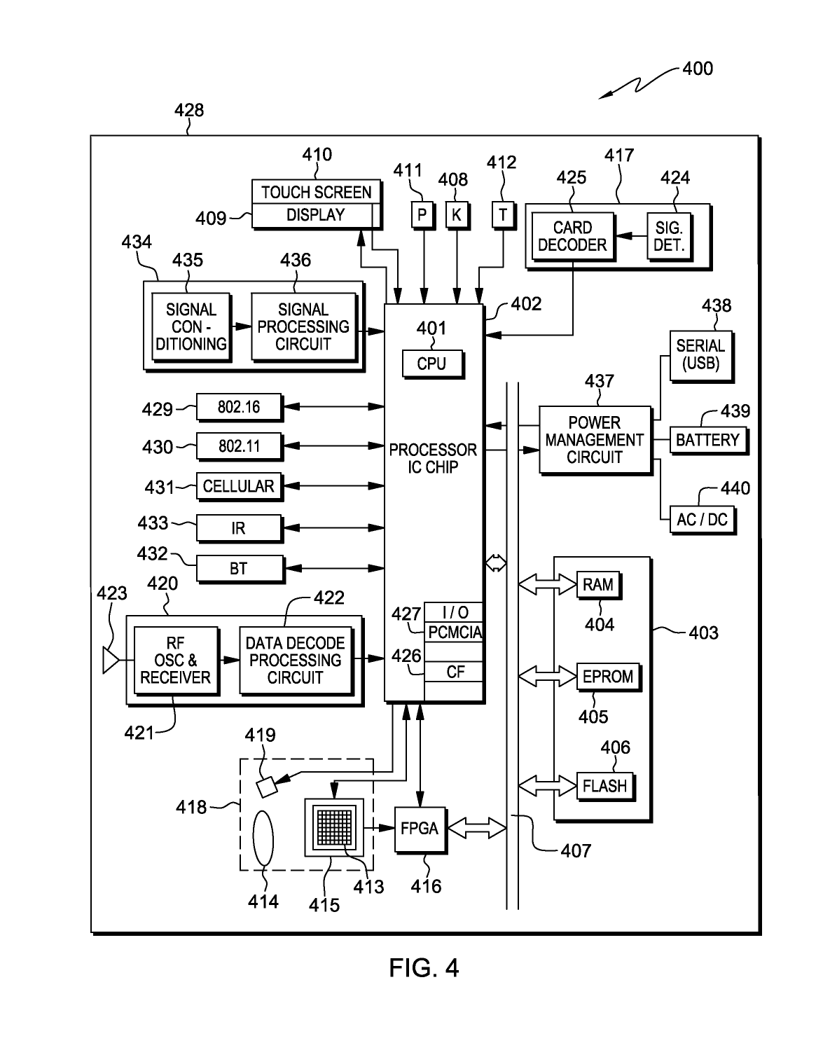

FIG. 4 depicts one example of a portable data terminal, in accordance with one or more aspects of the present invention. Portable data terminal (“device”) 400 is presented as a block diagram in FIG. 4. By operation of a control circuit 401, device 400 receives and processes various input such as location information data and transaction data, and controls various output such as the output of various collected transaction data. In the embodiment of FIG. 4, control circuit 401 comprises a central processing unit or CPU. CPU may be disposed on processor integrated circuit (IC) chip 402, while memory 403 may be incorporated partially in IC chip 402 and partially in a plurality of memory IC chips such as RAM IC chip 404, EPROM IC chip 405, and flash IC chip 406. EPROM IC chip 405, RAM IC chip 404, and flash IC chip 406 or other nonvolatile storage device may be in communication with processor IC chip 402 via system bus 407. Processor IC chip 402 operates in accordance with an Operating System (OS) which is typically loaded into RAM 404 when device 400 is booted up. The device's operating system enables processor IC chip 402 to recognize input from user input interface components, e.g., keyboard 408, send output to output interfaces e.g., display 409, schedule tasks, manage files, and directories and control other components such as input/output devices. Examples of suitable operating systems for device 400 include WINDOWS XP, LINUX, WINDOWS CE, OSX.

Referring to further elements of device 400, device 400 includes a display 409. Display 409 may have an associated touch screen overlay 410 so that display 409 operates as a data input interface. The combination of display 409 and touch screen overlay 410 can be regarded as a “touch screen.” Device 400 may further have a keyboard 408 enabling input of data. Device 400 may also include a graphical user interface (“GUI”) displayed on display 409. The GUI can include a pointer movable by an operator to select between various displayed (sometimes referred to as “virtual”) control buttons displayed on display 409. The pointer may be moved during web browsing to select a text or icon hyperlink for highlighting. Control buttons may also be displayed for selecting between various menu options. Device 400 can be configured so that displayed menu options are selected by physically depressing a displayed icon or text, with use of a finger or stylus. The control buttons may be a series of icons, and selecting one of the icons can change the mode of operation of device 400 in accordance with the selected icon. Device 400 includes a pointer controller 411 enabling movement of the pointer. In one specific embodiment, pointer controller 411 is provided by an arrow navigation matrix. Pointer controller 411 may also be provided by, e.g., a trackball, mouse, or a joystick. Device 400 further includes a trigger 412 for controlling various data input units of device 400. Trigger 412 is in communication with control circuit 401.

Device 400 as shown in FIG. 4 also includes an image signal generating system provided by two dimensional solid state image sensor 413, available in such technologies as CCD, CMOS, and CID. Two-dimensional solid state image sensors generally have a plurality of photosensor picture elements (“pixels”) which are formed in a pattern including a plurality of rows and a plurality of columns of pixels. Device 400 further includes imaging optic(s)/lens(es) 414 focusing an image onto an active surface of image sensor 413. Image sensor 413 may be incorporated on an image sensor IC chip 415 having disposed thereon image sensor control circuitry, image signal conditioning circuitry, and an analog-to-digital converter. Device 400 may further include a field programmable gate array 416 (“FPGA”). Operating under the control of control circuit 401, FPGA 416 manages the capture of image data into RAM 404.

When trigger button 412 is actuated with device 400 in a bar code decode mode of operation, control circuit 401 automatically sends appropriate control signals to image sensor chip 415. Image sensor chip 415 in response thereto automatically exposes photosensitive pixels of image sensor 413 to light and generates image signals. The image signals are thereafter automatically converted into digital values by image sensor IC chip 415. The digital values are received by FPGA 416 and transferred into RAM 404 to capture an electronic image representation of a substrate carrying a bar code symbol. In accordance with a bar code decoding program stored in EPROM 405, as an example, control circuit 401 may attempt to decode a bar code symbol represented in the captured electronic image representation. The capture of image data and decoding of image data occur automatically in response to a trigger signal being generated. A trigger signal can be generated when trigger 412 is actuated. Control circuit 401 may be configured to continuously capture image data and attempt to decode bar code symbols represented therein as long as trigger 412 is actuated. The electronic image representation captured into RAM 404 may be an image map having a pixel value (gray scale, color scale) for each pixel of the image sensor.

In addition to having a decode mode of operation, device 400 may also be configured to include an image capture mode of operation. In an image capture mode of operation, control circuit 401 captures an electronic image representation in response to trigger button 412 being actuated without attempting to decode a decodable symbol represented therein. The captured electronic image representation may be one or more of (i) stored into a designated memory location of memory 403, (ii) transmitted to an external spaced apart device (e.g., card reader unit 417) automatically or in response to a user input command, or (iii) displayed on display 409 automatically or in response to a user input command.

Imaging assembly/module 418, which in the embodiment described thus far includes an image sensor chip 415 and imaging optics 414, may be provided by an IT4XXX image engine of the type available from Hand Held Products, Inc., of Skaneateles Falls, N.Y. Imaging assembly 418 may also be an ImageTeam imaging module of the type available from Hand Held Products. Imaging module 418 includes, in one embodiment, a first circuit board and a second circuit board (not pictured). The first circuit board can carry image sensor IC chip 415 and aiming LEDs. A support is fitted over the first circuit board which has a retainer for carrying a lens barrel which contains imaging lens 414. The support further carries slits for shaping light from LEDs 419. With the support mounted on the first circuit board, the second circuit board can be fitted over the support. The second circuit board carries illumination LEDs 419 and receives power via electrically conductive support posts that are in electrical communication with the first circuit board. With second circuit board installed, an optical plate can be fitted over the second circuit board. The optical plate carries a substantially uniform diffuser surface for diffusing light from illumination LEDs 419 and lenses 414 for imaging slits onto a substrate. Illumination LEDs 419 together with the diffuser surface of the optical plate projects an illumination pattern onto the substrate. Aiming LEDs 419 together with the slits and lenses 414 project an aiming pattern onto a substrate.

The above-mentioned imaging assembly 418 includes an associated decode circuit which decodes various 1D and 2D bar codes, OCR fonts, and which is equipped with various image capture modes of operation. Imaging assembly 418 may also be provided by a laser scan engine, such as an SE2223 scan engine with decode circuit of the type available from Symbol Technologies, Inc., of Holtsville, N.Y.

The decode circuit of imaging module 418 can include a dedicated processor IC chip and various decode memory structures for storing decoding programs and working image data. In one example, in response to receipt of a trigger signal, imaging module 418 captures an image and the decode circuit thereof decodes a bar code to produce a decoded out message. The decode circuit may decode such symbologies as PDF417, MicroPDF417, MaxiCode, Data Matrix, QR Code, Aztec, Aztec Mesa, Code 49, UCC Composite, Snowflake, Dataglyphs, Code 39, Code 128, Codabar, UPC/EAN, Interleaved 2 or 5, RSS, Code 93, Codablock, BC 412, Postnet (US), Planet Code, BPO 4 State, Canadian 4 State, Japanese Post, Kix (Dutch Post) and OCR-A, OCR-B. In the circuit of FIG. 4, control circuit 401, in response to receipt of a trigger signal, utilizes the decode circuit of imaging assembly 415 to capture an electronic image representation and decode a bar code symbol represented therein to produce a decoded out message. A bar code decoding system in the embodiment of FIG. 4 includes control circuit 401 and a decode circuit of imaging module 418.

In another aspect, device 400 as shown in FIG. 4 includes a radio-frequency identification (RFID) reader unit 420. “RFID” as used herein includes near-field communication (NFC). RFID reader unit 420 includes an RF oscillation and receiver circuit 421 and a data decode processing circuit 422. RFID reader unit 420 may be configured to read RF encoded data from a passive RFID tag which may be disposed on an article remote from device 400, such as on a shipper-provided article. Where RFID reader unit 420 is configured to read RF encoded data from a passive RFID tag, RF oscillation and receiver circuit 421 transmits a carrier signal from antenna 423 to the passive tag. The passive RFID tag converts the carrier energy to voltage form and a transponder of the tag is actuated to transmit a radio signal representing the encoded tag data. RF oscillator and receiver circuit 421, in turn, receives the radio signal from the tag and converts the data into a processable digital format. Data decode processing circuit 422, that typically includes a low cost microcontroller IC chip, decodes the received radio signal information received by RF oscillator and receiver circuit 421 to decode the encoded identification data originally encoded into the RFID tag.

An RFID tag can be disposed on an RFID label which also includes an antenna, a transponder, and storage circuit for storing encoded identification data. Data (such as a cryptographic key) from the storage circuit of the RFID label is read from the RFID tag when the tag is activated by RFID reader unit 420. Further, reader unit 420 may write data to the tag. Data written to the tag by reader unit 420 may be e.g., new identification data. The tag may be incorporated in physical structures of other article labels. For instance, the tag may be incorporated on a smart card, an identification card, such as a package identification card, or a financial transaction card such as a credit card, a debit card, or an electronic benefits card, comprising a magnetic stripe.

RFID reader unit 420 may operate in a selective activation mode or in a continuous read operating mode. In a selective activation mode, RFID reader unit 420 broadcasts radio signals in an attempt to activate a tag or tags in its vicinity in response to an RFID trigger signal being received. In a continuous read mode, RFID reader module 420 continuously broadcasts radio signals in an attempt to actuate a tag or tags in proximity with unit automatically, without module 420 receiving a trigger signal. In a selective activation mode, RFID reader unit 420 selectively broadcasts radio signals in an attempt to activate a tag or tags in its vicinity selectively and automatically in response to a receipt by control circuit 401 of an RFID trigger signal. Device 400 may be configured so that control circuit 401 receives a trigger signal under numerous conditions, such as: (1) an RFID trigger button such as button 412 is actuated; (2) an RFID trigger instruction is received from a spaced apart device such as remote processor, or local host processor (such as card reader unit 417); and (3) control circuit 401 determines that a predetermined condition has been satisfied.

Still further, device 400 may include a card reader unit 417. Card reader unit 417 includes a signal detection circuit 424 and a data decode circuit 425. Signal detection circuit 424 receives an electrical signal from a card and data decode circuit 425 decodes data encoded in the signal. When data decode circuit 425 decodes a signal, the decoded-out information is transmitted to control circuit 401 for further processing. Card reader unit 417 can be included as part of a card reader (not pictured) which includes a housing and a card receiving slot defined by the housing. Card reader unit 417 is configured to read more than one type of card, in one example. Device 400, with use of card reader unit 417, may read e.g., smart cards, credit cards, customer loyalty cards, electronic benefits cards and identification cards such as employee identification cards and driver license cards. Card reader unit 417 can be selected to be of a type that reads card information encoded in more than one data format. Where card reader unit 417 is a Panasonic ZU-9A36CF4 Integrated Smart Reader, card reader unit 417 reads any one of magnetic stripe data, smart card or Integrated circuit card (IC card) data, and RF transmitted data. Where card reader unit 417 reads RF transmitted identification data via RFID reading capability thereof, the card reader may read RF transmitted identification data from a card when a card is inserted into slot, or else card reader unit 417 may read RF transmitted identification data from a card or another object (e.g., an RFID “key fob”) when the card or object is merely brought into proximity with the card reader without being inserted into the slot thereof. Accordingly, where card reader unit 417 is a Panasonic ZU-9A36CF4 Integrated Smart Reader, device 400 has dual RFID reader units; namely, RFID reader unit 420 and the RFID reader unit incorporated in card reader unit 417.

IC chip 402 may further include a plurality of serial I/O interfaces such as general purpose I/O, USB, and Ethernet interfaces and a plurality of parallel interfaces such as Compact Flash (CF 426) and PCMCIA (PC 427).

The components of FIG. 4 can be supported entirely within a hand held housing 428. Device 400 may include a system of interior support members extending from the interior walls of housing 428, for supporting a plurality of circuit boards, which, in turn, support various components of device 400, including integrated circuit components of device 400. Housing 428 of device 400 is configured to be portable, i.e. as a portable data terminal, so that it can be moved from location to location, and in one particular example accompany a package carrier on-location as packages are picked-up and delivered. Components shown in FIG. 4 can be supported within housing 428 i.e., on a support system including circuit boards and support members.

Selection of various modes of operation may be made with use of a GUI on display 409. Thus, display 409 may include a plurality of control buttons in the form of selection icons, such as bar code decoding icon, RFID decoding icon, location detection icon, image capture icon, and web browsing icon, as examples. High level operating systems, such as WINDOWS CE, GNU/Linux, and Symbian support GUI functionality. Selection of one of the icons drives device 400 into a mode of operation corresponding to the selected icon.

When the control button provided by an Internet icon is selected, device 400 is driven into a web browsing mode of operation. Device 400 may incorporate a web browser for enabling device 400 to be utilized for navigating between websites disposed within various servers of the Internet, e.g., servers of one or more local area networks. Available web browser software packages for hand held devices include Opera for Mobile by Opera Software, Netfront by Access, and Minimo by the Mozilla Foundation, WebPro 1.0 by Novarra, and/or WinWAP, available from Slob-Trot Software, Inc. and Pocket Internet Explorer available from Microsoft, Inc.

Selection of a bar code decoding icon on a GUI selection screen drives device 400 into a bar code reading mode of operation such that an actuation of trigger 412 subsequent to a bar code decode mode being selected results in control circuit 401 capturing an electronic image representation, subjecting the electronic image representation to a decode attempt and automatically outputting of a decoded message (e.g., a decoded message is one or more of (i) displayed on display 409 (ii) stored into RAM chip 404, or FLASH memory 406, and (iii) uploaded to a remote device such as device 417, where device 400 is located one a network.

Selection of the RFID decoding icon drives device 400 into an RFID decode mode of operation such that an actuation of trigger 412 subsequent to an RFID decode mode being selected results in control circuit 401 controlling RFID reader unit 420 to broadcast a radio frequency signal in attempt to activate RFID tags in a vicinity of device 400, automatically decoding an RFID tag encoded message carried by a received signal utilizing RFID reader unit 420, and automatically outputting a decoded RFID tag message, e.g., to display 409 and/or a server or device 417.

Selection of the image capture icon drives device 400 into a picture taking mode of operation such that a subsequent actuation of trigger 412 results in control circuit 401 automatically capturing a two-dimensional electronic image representation corresponding to the present field of view of imaging assembly 418 and automatically outputting the two-dimensional electronic image representation into one or more of (i) a memory of device 400, e.g., RAM 404 or FLASH 406 (ii) a remote e.g., remote server or device 417 (iii) display 409, as described previously herein without decoding being executed and without a decoded message being output. Device 400 can be configured so that the icons serve as triggers as well as mode selections. That is, device 400 can be configured so that actuation of one of the icons described above results in a trigger signal being generated and a certain operating mode being activated such that there is no need to actuate trigger 412 after an icon is actuated.

Device 400 may further include a plurality of communication links such as an 802.16 communication link 429, 802.11 communication link 430, cellular communication link 431 for communication with a cellular network such as a network in accordance with the Global System for Mobile Communications (GSM), Bluetooth communication link 432, and IR communication link 433, facilitating communication between device 400 and an external device remote (e.g. spaced apart) from device 400.

Device 400 may be part of a local area network (“LAN”) including a spaced apart and separately housed local host processor and other hand held devices. In one embodiment, the network is a cellular network, such as a GSM network. Where the cellular network is provided by a GSM network, the network supports packet based wireless communication in accordance with the General Packet Radio Service (GPRS). In another embodiment, the cellular network 1502 can be provided by a CDMA network. Cellular radio 431 can be a CDMA radio that connects to a CDMA network, including, but not limited to, Qualcomm's CDMA2000 1xRTT, CDMA2000 1xEV-DO, or W-CDMA/UMTS networks. Such cellular networks, including a GSM network and the listed CDMA networks, all support high-speed packet based wireless data transfer.

In addition to having wireless communication links, device 400 may include various physical connector interfaces such as a “D-connector” interface enabling hard wired RS 232 communication between external devices and host CPU 401. Additionally or alternatively, a USB physical connection interface can be provided to enable USB communication with devices, such as an external printer. Device 400 may further be in communication with a plurality of offsite remote host processors or servers located several miles to thousands of miles away from device 400. Remote host processors may be in communication with device 400 via a wide area network, which may be the Internet.

In another aspect, device 400 includes a location detection component 434. Location detection component 434 detects the physical location of device 400 and reports position information to a processor, such as control circuit 401. Specifically, in one embodiment, location detection component 434 outputs a “NMEA string” including coordinate location information, which string is parsed by control circuit 401. Location detection component 434 can receive signals from a series of satellites, which may be satellites of the Global Positioning System (GPS) or GLONASS. Each such satellite includes an atomic clock and reports time-stamped signals to location detection component 434. With a timing system that includes atomic clocks in each orbiting satellite, module 434 can determine a distance from location detection component 434 to a transmitting satellite. The present GPS system includes multiple operational GPS satellites orbiting the earth. When location detection component 434 receives signals from three of the satellites, location detection component 434 may determine a location (x,y coordinates) of device 400. When location detection component 434 receives signals from of the satellites, location detection component 434 may determine location of device 400 which includes, in addition to (x,y) coordinate values, (latitude and longitude) altitude information and (x,y,z) coordinate values. In determining a location of device 400, location detection component 434 determines its present distance from each of three satellites and extracts location information utilizing triangulation.

Location detection component 434 determines the position of device 400 by processing of signals from the satellites. Location detection component 434 may include a signal conditioning circuit 435 including such elements as a SAW filter, an RF converter, a frequency synthesizer, a reference oscillation, an analog-to-digital converter, and a signal processing unit 436 including such elements as a digital receiver and a processor IC chip. Signal conditioning circuit 435 may receive and condition signals from various satellites, and signal processing circuit 436 processes the received signals to determine such information as coordinate location information and velocity information. Signal processing circuit 436 produces output location data which is input to processor IC chip 402 and processed by control circuit 401. Location detection component 434 may be e.g., a GPS location detection component or a GLONASS location detection component or a combined GPS/GLONASS location detection component.

The output location data produced by location detection component 434 and received by control circuit 401 may include coordinate information, e.g., latitude/longitude coordinate values representing the current location of device 400. In particular, location detection component 434 may output serial digital data known as a “NMEA string” and control circuit 401, programmed to execute a NMEA string parsing software module, parses the input NMEA string to extract latitude and longitude coordinate values from the input NMEA string. Control circuit 401 may also extract other information, such as altitude and velocity values, from an input NMEA string.

In a further aspect, location detection component 434 may include mapping software stored therein. Signal processing circuit 436 may cross-reference calculated coordinate information with location information of the mapping software and report, together with coordinate location information, street address information. In addition to reporting location information, location detection component 434 may also report vector velocity information indicating a speed of travel of device 400.

In one particular embodiment, as described previously, location detection component 434 may be included behind a tamper-resistant boundary so as to, upon tampering with the tamper-resistant boundary, render location detection component 434 (or any portion of device 400) unusable, in order to protect the integrity of location data provided by location detection component 434.

In some embodiments, device 400 may be configured to detect a location of the device 400 by processing of signals in addition to, or other than, signals received by location detection component 434. For example, device 400 may be configured to receive at least one of location information or location indicating information from a network through a general data communication radio transceiver such as cellular radio transceiver 431 or radio transceivers 429, 430, and 432. Location detection systems may be divided into two main categories: “satellite based” and “network based.”

Satellite based location detection systems, as described above, such as GPS detection systems utilize dedicated hardware integrated into the device, e.g., hardware 434 into device 400, dedicated for purposes of receiving signals from a series of orbiting satellites, and a processing circuit such as control circuit 401 configured to process the signals into location information. In this manner, a satellite-based location detection system can be provided behind a secure boundary of device 400, such as a tamper-resistant boundary (e.g. 106 of FIG. 1).

In a network based location detection subsystem, an individual mobile device 400 may (1) receive location information from a network, such as a ground based network, the network including a processor that processes radio signals from one or more mobile devices to determine a location of one or more mobile device, (2) receive coarse location information from a ground based network based on the network's location, or (3) receive a location indicating network identifier (e.g., a cell ID of a cellular network, an SSID of an IEEE 802.11 network) from a network device from which coarse location information can be extracted by processing of the network identifier. A control circuit 401 can be configured to determine location information (e.g., location coordinates) from a network identifier by sending the network identifier as a key to a table correlating network identifiers with location coordinates. The tables can be disposed in memory 403 of device 400 within housing 428 or in another memory of system 90. In this regard, a network-based location detection system may be less secure than a satellite-based location detection system provided behind a tamper-resistant boundary of device 400. However, a network based location detection system that can provide the same level of protection against subjugation as a satellite-based or other form of location detection component behind a tamper-resistant boundary may be utilized in accordance with aspects of the present invention to provide location data as described above.

For mobile operation, device 400 can include a power management circuit 437 that supplies power to various components of device 400 and receives power from one of three power sources, namely serial power source 438 (e.g., USB), a battery power source 439, normally a rechargeable battery, and a transformer based AC/DC power source 440.

An exemplary parts list for some circuit components of FIG. 4 therefore includes: (i) for processor IC Chip 402—Intel PXA 255; (ii) for location detection component 434—Fastrax NPatch 100, or Qualcomm MSM7600 chipset (supports gpsONE); (iii) for 802.11 Radio 430—Sychip WLAN 6065; (iv) for cellular radio 431—Siemens MC46 or Qualcomm MSM7600; (v) for bluetooth radio 432—Socketcom; (vi) for RFID reader 420—Skyetek Sky Module M1 or Sky Module M8; (vii) for card reader 417—Panasonic ZU-9A36CF4; (viii) For image sensor chip 415—Micron MT9V022.

A small sample of systems methods and apparatus that are described herein is as follows:

A1. A method to facilitate verifying a source of a package, the method comprising: obtaining, by a data terminal certified by an authority, location data from a location detection component of the certified data terminal, the location data indicating a source location from which the package is to be shipped, the source location detected by the location detection component when at the source location; and providing, with the package, secure package shipment information, the secure package shipment information comprising the location data indicating the detected source location of the package, wherein the secure package shipment information securely conveys the detected source location of the package to facilitate verifying the source of the package.

A2. The method of A1, wherein the location detection component comprises a global positioning system device, the global positioning system device being included behind a tamper-resistant boundary of the data terminal, wherein certification of the data terminal by the authority certifies that the location data provided by the global positioning system device is trustworthy, and wherein tampering with the tamper-resistant boundary nullifies the certification of the data terminal.

A3. The method of A2, wherein a key issued by the authority to a carrier of the package is included behind the tamper-resistant boundary of the data terminal, wherein the key is used to secure package shipment information to thereby provide the secure package shipment information, and wherein tampering with the tamper-resistant boundary erases the key.

A4. The method of A1, wherein providing the secure package shipment information comprises performing at least one selected from the group consisting of (i) encrypting the location data using at least one key and (ii) electronically signing the location data with a digital signature using at least one key, and wherein the encrypted or the electronically signed location data comprises at least a portion of the secure package shipment information.

A5. The method of A4, wherein the location data is combined with additional shipment information to obtain package shipment information, and wherein the encrypting or the electronically signing the location data comprises encrypting or electronically signing the package shipment information including the location data.

A6. The method of A4, wherein the at least one key comprises at least one selected from the group consisting of (i) a key issued by the authority to a carrier responsible for shipping the package and (ii) a key provided by a shipper of the package.

A7. The method of A1, wherein the secure package shipment information comprises encoded information, wherein the providing includes generating a package source label comprising the encoded information, and wherein the source label is affixed to the package.

A8. The method of A1, wherein the method further comprises, upon receipt of the package at a receiving location, using a key to perform at least one selected from the group consisting of (i) decrypting at least a portion of the secure package shipment information and (ii) verifying validity of a digital signature of at least a portion of the secure package shipment information.

A9. The method of A8, wherein based on the decrypting or the verifying, package shipment information is obtained, the package shipment information comprising the location data indicating the detected source location, and wherein the method further comprises comparing the detected source location with a known location of an expected source of the package, wherein a match between the detected source location and the known location verifies that the source of the package is the expected source of the package.

A10. The method of A8, wherein the data terminal includes a private key issued to a carrier of the package by the authority as part of the certification of the data terminal, the private key being included behind a tamper-resistant boundary of the data terminal, wherein the providing comprises electronically signing the location data with a digital signature using the private key issued by the authority to the carrier, wherein, upon receipt of the package at a receiving location by the authority, a public key corresponding to the private key is used to verify validity of the digital signature and obtain package shipment information comprising the location data indicating the detected source location, and wherein the detected source location is compared against at least one whitelisted location that is known to be trustworthy or at least one blacklisted location that is known to be untrustworthy.

A11. A system for facilitating verification of a source of a package, the system comprising: a data terminal comprising: a processor; a location detection component; and a memory in communication with the processor and storing instructions for execution to perform a method comprising: obtaining location data from the location detection component, the location data indicating a source location from which the package is to be shipped, the source location detected by the location detection component when at the source location; and providing, with the package, secure package shipment information, the secure package shipment information comprising the location data indicating the detected source location of the package, wherein the secure package shipment information securely conveys the detected source location of the package to facilitate verifying the source of the package, and wherein the data terminal is certified by an authority to provide the secure package shipment information.

A12. The system of A11, wherein the location detection component comprises a global positioning system device, the global positioning system device being included behind a tamper-resistant boundary of the system, wherein certification of the data terminal by the authority certifies that the location data provided by the global positioning system device is trustworthy, and wherein tampering with the tamper-resistant boundary nullifies the certification of the data terminal.

A13. The system of A11, wherein providing the secure package shipment information comprises performing at least one selected from the group consisting of (i) encrypting the location data using at least one key and (ii) electronically signing the location data with a digital signature using at least one key, and wherein the encrypted or the electronically signed location data comprises at least a portion of the secure package shipment information.

A14. The system of A13, wherein the at least one key comprises at least one selected from the group consisting of (i) a key issued by the authority to a carrier responsible for shipping the package and (ii) a key provided by a shipper of the package.

A15. The system of A11, further comprising a recipient data terminal, the recipient data terminal for performing a verification method comprising: upon receipt of the package at a receiving location, using a key to perform at least one selected from the group consisting of (i) decrypting at least a portion of the secure package shipment information and (ii) verifying validity of a digital signature of at least a portion of the secure package shipment information.

A16. The system of A15, wherein based on the decrypting or the verifying, package shipment information is obtained, the package shipment information comprising the location data indicating the detected source location, and wherein the verification method further comprises comparing the detected source location with a known location of an expected source of the package, wherein a match between the detected source location and the known location verifies that the source of the package is the expected source of the package.

A17. A computer program product for facilitating verification of a source of a package, the computer program product comprising: a computer readable storage medium readable by a processor and storing instructions for execution by the processor to perform a method comprising: obtaining, by a data terminal certified by an authority, location data from a location detection component of the certified data terminal, the location data indicating a source location from which the package is to be shipped, the source location detected by the location detection component when at the source location; and providing, with the package, secure package shipment information, the secure package shipment information comprising the location data indicating the detected source location of the package, wherein the secure package shipment information securely conveys the detected source location of the package to facilitate verifying the source of the package.

A18. The computer program product of A17, wherein the location detection component comprises a global positioning system device, the global positioning system device being included behind a tamper-resistant boundary of the data terminal, wherein certification of the data terminal by the authority certifies that the location data provided by the global positioning system device is trustworthy, and wherein tampering with the tamper-resistant boundary nullifies the certification of the data terminal.

A19. The computer program product of A18, wherein a key issued by the authority to a carrier of the package is included behind the tamper-resistant boundary of the data terminal, wherein the key is used to secure package shipment information to thereby provide the secure package shipment information, and wherein tampering with the tamper-resistant boundary erases the key.

A20. The computer program product of A17, wherein providing the secure package shipment information comprises performing at least one selected from the group consisting of (i) encrypting the location data using at least one key and (ii) electronically signing the location data with a digital signature using at least one key, and wherein the encrypted or the electronically signed location data comprises at least a portion of the secure package shipment information.

A21. The computer program product of A20, wherein the at least one key comprises at least one selected from the group consisting of (i) a key issued by the authority to a carrier responsible for shipping the package and (ii) a key provided by a shipper of the package.

A22. A portable data terminal for facilitating verification of a source of a package, the portable data terminal being certified by an authority, and the portable data terminal comprising: a processor; a global positioning system device, the global positioning system device providing, to the processor, location data indicating a source location from which the package is to be shipped, the source location detected by the global positioning device when at the source location, wherein the global positioning system device is present behind a tamper-resistant boundary of the portable data terminal, wherein certification of the portable data terminal by the authority certifies that the location data provided by the global positioning system device is trustworthy, and wherein tampering with the tamper-resistant boundary nullifies the certification of the portable data terminal; and a memory in communication with the processor and storing instructions for execution to perform a method comprising: using a key verified by the authority and included behind the tamper-resistant boundary of the portable data terminal to perform at least one selected from the group consisting of (i) encrypting package shipment information to obtain secure package shipment information and (ii) signing package shipment information to obtain secure package shipment information, and wherein tampering with the tamper-resistant boundary erases the key; and providing, with the package, the secure package shipment information, wherein the secure package shipment information securely conveys the detected source location of the package to facilitate verifying the source of the package.

A23. The portable data terminal of A22, wherein the key verified by the authority comprises a private key issued by the authority to a carrier of the package as part of the certification of the portable data terminal by the authority, wherein the private key is used to sign the package shipment information, and wherein a public key issued by the authority is used to encrypt the signed package shipment information to obtain the secure package shipment information.

Those having ordinary skill in the art will recognize that aspects of the present invention may be embodied in one or more systems, one or more methods and/or one or more computer program products. In some embodiments, aspects of the present invention may be embodied entirely in hardware, entirely in software (for instance in firmware, resident software, micro-code, etc.), or in a combination of software and hardware aspects that may all generally be referred to herein as a “system” and include circuit(s) and/or module(s).

In some embodiments, aspects of the present invention may take the form of a computer program product embodied in one or more computer readable medium(s). The one or more computer readable medium(s) may have embodied thereon computer readable program code. Various computer readable medium(s) or combinations thereof may be utilized. For instance, the computer readable medium(s) may comprise a computer readable storage medium, examples of which include (but are not limited to) one or more electronic, magnetic, optical, or semiconductor systems, apparatuses, or devices, or any suitable combination of the foregoing. Example computer readable storage medium(s) include, for instance: an electrical connection having one or more wires, a portable computer diskette, a hard disk or mass-storage device, a random access memory (RAM), read-only memory (ROM), and/or erasable-programmable read-only memory such as EPROM or Flash memory, an optical fiber, a portable compact disc read-only memory (CD-ROM), an optical storage device, a magnetic storage device (including a tape device), or any suitable combination of the above. A computer readable storage medium is defined to comprise a tangible medium that can contain or store program code for use by or in connection with an instruction execution system, apparatus, or device, such as a processor. The program code stored in/on the computer readable medium therefore produces an article of manufacture (such as a “computer program product”) including program code.

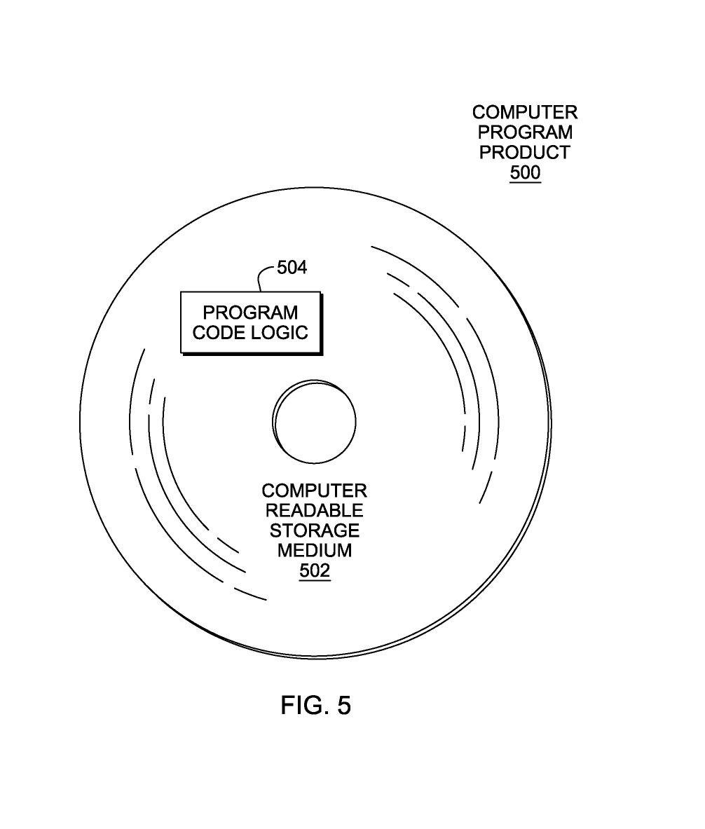

Referring now to FIG. 5, in one example, a computer program product 500 includes, for instance, one or more computer readable media 502 to store computer readable program code means or logic 504 thereon to provide and facilitate one or more aspects of the present invention.

Program code contained or stored in/on a computer readable medium can be obtained and executed by a data processing system (computer, computer system, etc. including a component thereof) and/or other devices to cause the data processing system, component thereof, and/or other device to behave/function in a particular manner. The program code can be transmitted using any appropriate medium, including (but not limited to) wireless, wireline, optical fiber, and/or radio-frequency. Program code for carrying out operations to perform, achieve, or facilitate aspects of the present invention may be written in one or more programming languages. In some embodiments, the programming language(s) include object-oriented and/or procedural programming languages such as C, C++, C#, Java, etc. Program code may execute entirely on the user's computer, entirely remote from the user's computer, or a combination of partly on the user's computer and partly on a remote computer. In some embodiments, a user's computer and a remote computer are in communication via a network such as a local area network (LAN) or a wide area network (WAN), and/or via an external computer (for example, through the Internet using an Internet Service Provider).

In one example, program code includes one or more program instructions obtained for execution by one or more processors. Computer program instructions may be provided to one or more processors of, e.g., one or more data processing system, to produce a machine, such that the program instructions, when executed by the one or more processors, perform, achieve, or facilitate aspects of the present invention, such as actions or functions described in flowcharts and/or block diagrams described herein. Thus, each block, or combinations of blocks, of the flowchart illustrations and/or block diagrams depicted and described herein can be implemented, in some embodiments, by computer program instructions.

The flowcharts and block diagrams depicted and described with reference to the Figures illustrate the architecture, functionality, and operation of possible embodiments of systems, methods and/or computer program products according to aspects of the present invention. These flowchart illustrations and/or block diagrams could, therefore, be of methods, apparatuses (systems), and/or computer program products according to aspects of the present invention.

In some embodiments, as noted above, each block in a flowchart or block diagram may represent a module, segment, or portion of code, which comprises one or more executable instructions for implementing the specified behaviors and/or logical functions of the block. Those having ordinary skill in the art will appreciate that behaviors/functions specified or performed by a block may occur in a different order than depicted and/or described, or may occur simultaneous to, or partially/wholly concurrent with, one or more other blocks. Two blocks shown in succession may, in fact, be executed substantially concurrently, or the blocks may sometimes be executed in the reverse order. Additionally, each block of the block diagrams and/or flowchart illustrations, and combinations of blocks in the block diagrams and/or flowchart illustrations, can be implemented wholly by special-purpose hardware-based systems, or in combination with computer instructions, that perform the behaviors/functions specified by a block or entire block diagram or flowchart.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than or greater than the mentioned certain number of elements. Also, while a number of particular embodiments have been described, it will be understood that features and aspects that have been described with reference to each particular embodiment can be used with each remaining particularly described embodiment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method to facilitate verifying a source of a package, the method comprising:
obtaining, by a data terminal certified by an authority, location data from a location detection component of the certified data terminal, the location data indicating a source location from which the package is to be shipped, the source location detected by the location detection component when at the source location; and
providing, with the package, secure package shipment information, the secure package shipment information comprising the location data indicating the detected source location of the package, wherein the secure package shipment information securely conveys the detected source location of the package to facilitate verifying the source of the package.

2. The method of claim 1, wherein the location detection component comprises a global positioning system device, the global positioning system device being included behind a tamper-resistant boundary of the data terminal, wherein certification of the data terminal by the authority certifies that the location data provided by the global positioning system device is trustworthy, and wherein tampering with the tamper-resistant boundary nullifies the certification of the data terminal.

3. The method of claim 2, wherein a key issued by the authority to a carrier of the package is included behind the tamper-resistant boundary of the data terminal, wherein the key is used to secure package shipment information to thereby provide the secure package shipment information, and wherein tampering with the tamper-resistant boundary erases the key.

4. The method of claim 1, wherein providing the secure package shipment information comprises performing at least one selected from the group consisting of (i) encrypting the location data using at least one key and (ii) electronically signing the location data with a digital signature using at least one key, and wherein the encrypted or the electronically signed location data comprises at least a portion of the secure package shipment information.

5. The method of claim 4, wherein the location data is combined with additional shipment information to obtain package shipment information, and wherein the encrypting or the electronically signing the location data comprises encrypting or electronically signing the package shipment information including the location data.

6. The method of claim 4, wherein the at least one key comprises at least one selected from the group consisting of (i) a key issued by the authority to a carrier responsible for shipping the package and (ii) a key provided by a shipper of the package.

7. The method of claim 1, wherein the secure package shipment information comprises encoded information, wherein the providing includes generating a package source label comprising the encoded information, and wherein the source label is affixed to the package.

8. The method of claim 1, wherein the method further comprises, upon receipt of the package at a receiving location, using a key to perform at least one selected from the group consisting of (i) decrypting at least a portion of the secure package shipment information and (ii) verifying validity of a digital signature of at least a portion of the secure package shipment information.

9. The method of claim 8, wherein based on the decrypting or the verifying, package shipment information is obtained, the package shipment information comprising the location data indicating the detected source location, and wherein the method further comprises comparing the detected source location with a known location of an expected source of the package, wherein a match between the detected source location and the known location verifies that the source of the package is the expected source of the package.

10. The method of claim 8, wherein the data terminal includes a private key issued to a carrier of the package by the authority as part of the certification of the data terminal, the private key being included behind a tamper-resistant boundary of the data terminal, wherein the providing comprises electronically signing the location data with a digital signature using the private key issued by the authority to the carrier, wherein, upon receipt of the package at a receiving location by the authority, a public key corresponding to the private key is used to verify validity of the digital signature and obtain package shipment information comprising the location data indicating the detected source location, and wherein the detected source location is compared against at least one whitelisted location that is known to be trustworthy or at least one blacklisted location that is known to be untrustworthy.

11. A system for facilitating verification of a source of a package, the system comprising:
a data terminal comprising:
a processor;
a location detection component; and
a memory in communication with the processor and storing instructions for execution to perform a method comprising:
obtaining location data from the location detection component, the location data indicating a source location from which the package is to be shipped, the source location detected by the location detection component when at the source location; and
providing, with the package, secure package shipment information, the secure package shipment information comprising the location data indicating the detected source location of the package, wherein the secure package shipment information securely conveys the detected source location of the package to facilitate verifying the source of the package, and wherein the data terminal is certified by an authority to provide the secure package shipment information.

12. The system of claim 11, wherein the location detection component comprises a global positioning system device, the global positioning system device being included behind a tamper-resistant boundary of the system, wherein certification of the data terminal by the authority certifies that the location data provided by the global positioning system device is trustworthy, and wherein tampering with the tamper-resistant boundary nullifies the certification of the data terminal.

13. The system of claim 11, wherein providing the secure package shipment information comprises performing at least one selected from the group consisting of (i) encrypting the location data using at least one key and (ii) electronically signing the location data with a digital signature using at least one key, and wherein the encrypted or the electronically signed location data comprises at least a portion of the secure package shipment information.

14. The system of claim 13, wherein the at least one key comprises at least one selected from the group consisting of (i) a key issued by the authority to a carrier responsible for shipping the package and (ii) a key provided by a shipper of the package.

15. The system of claim 11, further comprising a recipient data terminal, the recipient data terminal for performing a verification method comprising:
upon receipt of the package at a receiving location, using a key to perform at least one selected from the group consisting of (i) decrypting at least a portion of the secure package shipment information and (ii) verifying validity of a digital signature of at least a portion of the secure package shipment information.

16. The system of claim 15, wherein based on the decrypting or the verifying, package shipment information is obtained, the package shipment information comprising the location data indicating the detected source location, and wherein the verification method further comprises comparing the detected source location with a known location of an expected source of the package, wherein a match between the detected source location and the known location verifies that the source of the package is the expected source of the package.

17. A computer program product for facilitating verification of a source of a package, the computer program product comprising:
a computer readable storage medium readable by a processor and storing instructions for execution by the processor to perform a method comprising:
obtaining, by a data terminal certified by an authority, location data from a location detection component of the certified data terminal, the location data indicating a source location from which the package is to be shipped, the source location detected by the location detection component when at the source location; and
providing, with the package, secure package shipment information, the secure package shipment information comprising the location data indicating the detected source location of the package, wherein the secure package shipment information securely conveys the detected source location of the package to facilitate verifying the source of the package.

18. The computer program product of claim 17, wherein the location detection component comprises a global positioning system device, the global positioning system device being included behind a tamper-resistant boundary of the data terminal, wherein certification of the data terminal by the authority certifies that the location data provided by the global positioning system device is trustworthy, and wherein tampering with the tamper-resistant boundary nullifies the certification of the data terminal.

19. The computer program product of claim 18, wherein a key issued by the authority to a carrier of the package is included behind the tamper-resistant boundary of the data terminal, wherein the key is used to secure package shipment information to thereby provide the secure package shipment information, and wherein tampering with the tamper-resistant boundary erases the key.

20. The computer program product of claim 17, wherein providing the secure package shipment information comprises performing at least one selected from the group consisting of (i) encrypting the location data using at least one key and (ii) electronically signing the location data with a digital signature using at least one key, and wherein the encrypted or the electronically signed location data comprises at least a portion of the secure package shipment information.

21. The computer program product of claim 20, wherein the at least one key comprises at least one selected from the group consisting of (i) a key issued by the authority to a carrier responsible for shipping the package and (ii) a key provided by a shipper of the package.

22. A portable data terminal for facilitating verification of a source of a package, the portable data terminal being certified by an authority, and the portable data terminal comprising:
a processor;
a global positioning system device, the global positioning system device providing, to the processor, location data indicating a source location from which the package is to be shipped, the source location detected by the global positioning device when at the source location, wherein the global positioning system device is present behind a tamper-resistant boundary of the portable data terminal, wherein certification of the portable data terminal by the authority certifies that the location data provided by the global positioning system device is trustworthy, and wherein tampering with the tamper-resistant boundary nullifies the certification of the portable data terminal; and
a memory in communication with the processor and storing instructions for execution to perform a method comprising:
using a key verified by the authority and included behind the tamper-resistant boundary of the portable data terminal to perform at least one selected from the group consisting of (i) encrypting package shipment information to obtain secure package shipment information and (ii) signing package shipment information to obtain secure package shipment information, and wherein tampering with the tamper-resistant boundary erases the key; and
providing, with the package, the secure package shipment information, wherein the secure package shipment information securely conveys the detected source location of the package to facilitate verifying the source of the package.

23. The portable data terminal of claim 22, wherein the key verified by the authority comprises a private key issued by the authority to a carrier of the package as part of the certification of the portable data terminal by the authority, wherein the private key is used to sign the package shipment information, and wherein a public key issued by the authority is used to encrypt the signed package shipment information to obtain the secure package shipment information.
